(19) United States
(12) Patent Application Publication
(10) Pub. No.: US 2011/0273969 A1
(43) Pub. Date: Nov. 10, 2011

(54) TIMEPIECE INCLUDING A PIVOTING MEMBER

(75) Inventors: Stephen Forsey, Les Brenets (CH); Robert Greubel, Lignieres (CH)

(73) Assignee: COMPLITIME SA, La Chaux-de-Fonds (CH)

(21) Appl. No.: 13/141,876

(22) PCT Filed: Dec. 16, 2009
(86) PCT No.: PCT/EP2009/067261

§ 371 Date: Jun. 23, 2011

(30) Foreign Application Priority Data
Dec. 24, 2008 (CH) 02020/08

(51) Int. Cl. G04B 31/00

(52) U.S. Cl. 368/324

(57) ABSTRACT

A timepiece includes a frame (1a, 1b) and a gear pivotably mounted on the frame (1a, 1b) via at least one pivoting member (5a, 5b) which includes a bearing and a pivot inserted in the bearing, at least the contact surfaces of the bearing and the pivot being made from at least one material with an intrinsically low friction coefficient and a low wear rate, the gear including at least one plate (2a, 2b) provided with a first hole (3a, 3b). The pivoting member includes a first plate (6a, 6b) provided with a second hole (8a, 8b) and forming the bearing, and a second plate (7a, 7b) provided with a small rod (9a, 9b) inserted in the first and second holes and forming the pivot, one of the first (6a, 6b) and second (7a, 7b) plates being rigidly connected to the gear and the other to the frame (1a, 1b).

### TECHNICAL FIELD

The present invention relates to a timepiece comprising a frame and a wheel pivotably mounted on said frame using at least one pivoting member that comprises a bearing and a pivot engaged in said bearing, the bearing and the pivot having at least their contact surfaces made from at least one material intrinsically having a low coefficient of friction and a low wear rate, the wheel including at least one board provided with a first hole. The term “wheel” should be understood broadly. The pivoting member could also be applied to other mobile pieces of the timepiece, such as the pallet of the escapement, for example.

### BACKGROUND OF THE INVENTION

Generally, a wheel pivotably mounted on a frame includes an arbor provided at both ends with pivots, each engaged in a bearing. Pivoting members formed by a bearing and a pivot are traditionally used to ensure axial and radial positioning of the rotating pieces present in the clockwork movements.

The pivot is generally made from steel and the bearing is for example made of brass, bronze, or ruby, the pairs of materials being chosen so that the frictional torque between the bearing and the pivot is as low and constant as possible.

However, pivoting members made from these pairs of materials are not always fully satisfactory regarding the value of the frictional torque and the wear obtained. They require the addition of a lubricant, inserted between the bearing and the pivot, which tends to deteriorate with time.

According to other methods described for example in documents U.S. Pat. No. 5,515,607, JP 09 211149, and DE 70 00 616, it is possible to make a wheel forming a single piece with the pivot. Such wheels comprising an integrated pivot are not the subject-matter of the present invention.

One aim of the present invention is to be able to use, in a timepiece, pivoting members whereof the contact surfaces are made from materials intrinsically having a low coefficient of friction and a low wear rate, i.e. not requiring such an addition of lubricant. This is the case in particular for bearings and pivots whereof the contact surfaces are made from diamond, another material, or a mixture of materials whereof the coefficient of friction is below 0.10. Unfortunately, such pieces are extremely difficult to manufacture using the regular machining techniques. They can for example be obtained by the method described in patent EP 1 622 826.

In particular, it is extremely difficult to product pieces as complex as a wheel arbor using the traditional methods. For example, it is extremely difficult to cut or assemble diamond pieces by riveting.

Another aim of the present invention is to propose a timepiece whereof the elements made from materials intrinsically having very low coefficients of friction and a low wear rate, i.e. not requiring the addition of lubricant, can easily be assembled.

### BRIEF DESCRIPTION OF THE INVENTION

To that end, and according to the present invention, a timepiece is proposed comprising a frame and a wheel pivotably mounted on said frame using at least one pivoting member that comprises a bearing and a pivot engaged in said bearing, the bearing and the pivot having at least their contact surfaces made from at least one material intrinsically having a low coefficient of friction and a low wear rate, i.e. not requiring the addition of a lubricant, the wheel having at least one board provided with a first hole. According to the invention, said pivoting member comprises a first plate provided with a second hole and forming the bearing, and a second plate provided with a pivot-shank engaged in said first and second holes, and forming the pivot, said first and second plates being made integral one with the wheel, the other with the frame.

According to alternative embodiments, the second plate to form the pivot can comprise a planar element from which a cylindrical element forming the pivot-shank protrudes, the two elements being made in a single piece, or a planar element and a cylindrical element, forming the pivot-shank, separate.

According to the alternatives, the second plate can comprise, on the side opposite the pivot-shank, a shaft made integral with the second plate and the frame. Said shaft can be mounted passing through said second plate and in said pivot-shank.

According to the alternatives, the board provided with the first hole and the first plate, provided with the second hole can be merged, said first and second holes then being merged. However, regarding the second plate provided with a pivot-shank forming the pivot, said second plate is always separate from the board of the wheel, provided with the first hole, so that the pivot is never integrated into said wheel.

According to the alternatives, the wheel can include two boards provided with a first hole and made integral in rotation, each board respectively being pivotably mounted in the frame using said pivoting member. To be made integral in rotation, said boards can comprise, around their first respective hole, a metal ring. In another embodiment, said boards can respectively comprise complementary assembling means, such as lugs, arranged to cooperate together and make said boards integral in rotation.

In the alternatives where the wheel has two boards, the shaft provided on the second plate of the pivoting members can be mounted passing through the second plate and in the pivot-shank of the pivoting member of each board of the wheel.

Preferably, the material intrinsically having a low coefficient of friction and a low wear rate, constituting at least the contact surfaces of the bearing and the pivot, is diamond.

### BRIEF DESCRIPTION OF THE DRAWINGS

Other features of the present invention will appear more clearly upon reading the following description, done in reference to the appended drawings, in which:

FIGS. 1 and 2 are respectively a cross-sectional view of a first alternative of the invention and a perspective view of the wheel,

FIG. 3 is a cross-sectional view of another alternative of the invention,

FIG. 4 is a cross-sectional view of another alternative of the invention,

FIG. 5 is a detailed cross-sectional view showing the plate forming the pivot and the shaft, according to the alternative of FIG. 4,

FIG. 6 is a perspective view of the wheel used in the alternative of FIG. 4,

FIG. 7 is a perspective view of the plate forming a pivot used in the alternative of FIG. 4,

FIG. 8 is a cross-sectional view of another alternative of the invention,

FIG. 9 is a perspective view of a shaft used in the alternative of FIG. 8, and

FIG. 10 is a cross-sectional view of another alternative of the invention.

### DETAILED DESCRIPTION OF THE INVENTION

In this description, a material intrinsically having a low coefficient of friction and a low wear rate is any material ensuring its own lubrication, without the help of an external lubricant. Preferably, this coefficient of friction is less than or equal to 0.1. Furthermore, such a material must be hard enough to have a very low wear rate. Preferably, said material has a hardness greater than or equal to 9 on the Mohs scale. Preferably, said material is diamond. Any other material having a coefficient of friction and a wear rate equivalent to those of diamond can be used. Likewise, it is possible to use diamond with another material, or any other mixture of materials having a coefficient of friction and a wear rate equivalent to those of diamond alone.

In this description, at least the contact surfaces between the different elements of the timepiece, with the exception of the frame, are made from at least one material intrinsically having a low coefficient of friction and a low wear rate. The elements can also be made entirely from a material intrinsically having a low coefficient of friction and a low wear rate. The frame or only the surface thereof can be made from at least one material intrinsically having a low coefficient of friction and a low wear rate, or any other material.

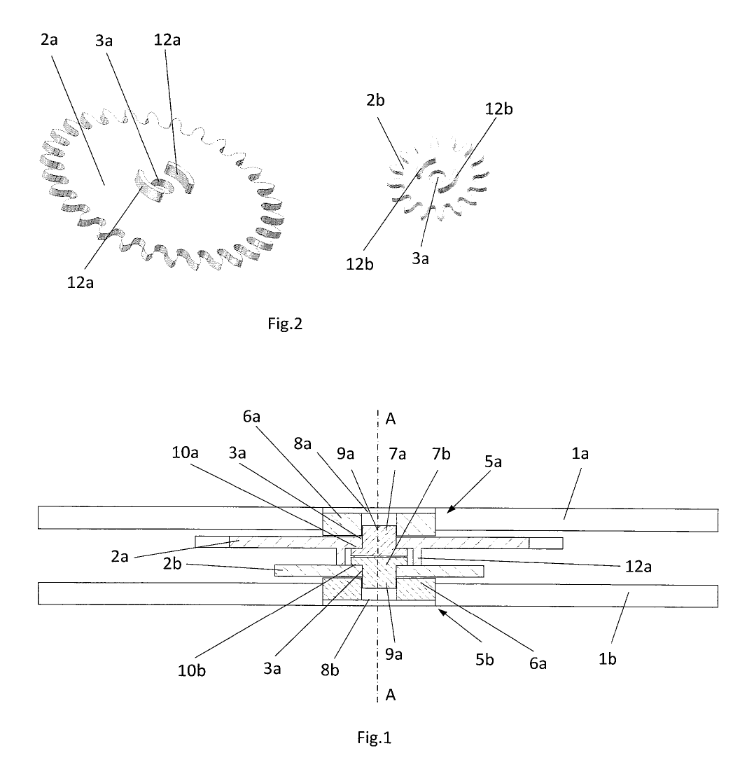

FIGS. 1 and 2 show a first alternative of a timepiece comprising a metal frame formed by a bridge 1a and a bottom plate 1b, and a wheel having a first board 2a provided with a toothing and a hole 3a, and a second board 2b provided with a toothing and a hole 3b. The boards 2a, 2b are made from diamond, for example by CVD.

The wheel is pivotably mounted around an axis AA on the bridge 1a and the bottom plate 1b using two pivoting members 5a and 5b, which each respectively comprise a bearing and a pivot engaged in their respective bearing.

According to the invention, each bearing is formed by a first plate 6a, 6b provided with a hole 8a, 8b, made from diamond, and made integral with the bridge 1a and the bottom plate 1b, respectively, by driving in or adhesion in a corresponding cutout provided on the bridge 1a and the bottom plate 1b. The plates 6a, 6b are arranged so that their holes 8a, 8b are placed opposite holes 3a, 3b of the boards 2a, 2b.

Of course it is possible to make the bridge or the bottom plate from diamond, comprising a hole for receiving the pivot-shank of the second plate, forming the pivot, the first plate provided with the hole and forming the bearing, which is then an integral part of said frame.

Each pivot is formed using a second plate 7a, 7b comprising a planar element from which a cylindrical element protrudes, perpendicular to the planar element and forming a pivot-shank 9a, 9b so that there is an annular peripheral rim 10a, 10b, against which the board 2a, 2b is axially positioned, respectively, making it possible to maintain the plates 7a, 7b between the two boards 2a and 2b, and to make the second plates 7a, 7b respectively integral with the boards 2a, 2b. The plate 7a, 7b is made from diamond.

According to the invention, the pivot-shank 9a, 9b is respectively engaged in the hole 3a, 3b of the board 2a, 2b and in the hole 8a, 8b of the first plate 6a, 6b. To that end, the diameter of the pivot-shank 9a, 9b is smaller than that of the hole 8a, 8b of the plate 6a, 6b and of the hole 3a, 3b of the board 2a, 2b, respectively.

The boards 2a and 2b respectively comprise two lugs 12a, 12b in the form of two angular sectors protruding from said board. The two lugs 12a, 12b, respectively, are arranged opposite each other concentrically to the hole 3a, 3b, respectively. The lugs 12a and 12b are arranged complementarily to cooperate in pairs and make the boards 2a and 2b integral in rotation. The accumulated thickness of the two rims 10a and 10b is substantially equal to the height of the lugs 12a or 12b, so as to ensure maintenance of the plates 7a and 7b without shaking.

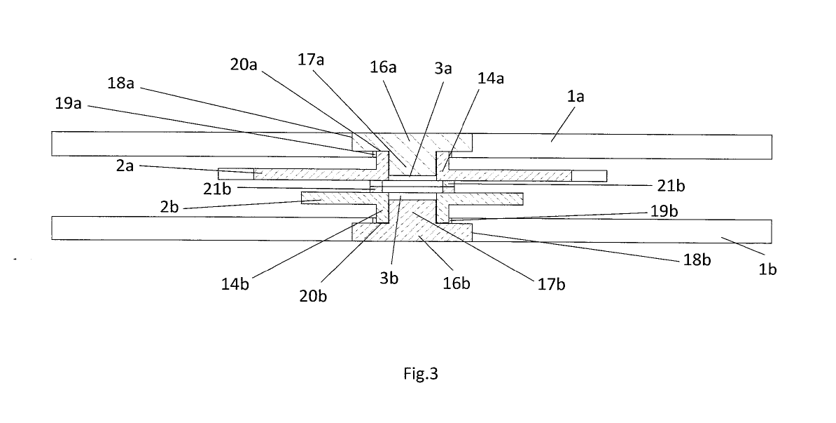

FIG. 3 shows another alternative embodiment of the invention. The elements shared with the first alternative are shown with the same references. The timepiece comprises a metal frame formed by a bridge 1a and a bottom plate 1b, and a wheel having a first board 2a provided with a toothing and a hole 3a, and a second board 2b provided with a toothing and a hole 3b. In this alternative, each hole 3a, 3b is bordered by a skirt 14a, 14b, respectively, protruding towards the bridge 1a and the bottom plate 1b, respectively. The boards 2a, 2b and their collars 14a, 14b are made from diamond, for example by CVD.

The wheel is pivotably mounted on the bridge 1a and the bottom plate 1b using two pivoting members that each respectively comprise a bearing and a pivot engaged in their respective bearing.

In this alternative, the plate provided with a hole forming the bearing of the first pivoting member is merged with the board 2a provided with the hole 3a and the collar 14a, said plate then being integral with the wheel. Likewise, the plate provided with a hole forming the bearing of the other pivoting member is merged with the board 2b provided with the hole 3b and the collar 14b.

Each pivot is formed by at least one second plate 16a, 16b comprising a planar element from which a cylindrical element protrudes, perpendicular to the planar element and forming a pivot-shank 17a, 17b. As for all of the other alternatives of the invention, the second plate is never merged with the board of the wheel, such that the pivot belongs to a piece separate from the wheel. The bridge 1a and the bottom plate 1b respectively include a housing 18a, 18b, in which the planar element of the plate 16a, 16b is housed, and a cutout 19a, 19b with smaller dimensions, for the passage of the pivot-shank 17a, 17b, such that there is an annular peripheral rim 20a, 20b in which the collar 14a, 14b of the board 2a, 2b circulates, respectively. The plate 16a, 16b is made from diamond and is made integral with the bridge 1a and the bottom plate 1b respectively by driving in or by adhesion.

According to the invention, the pivot-shank 17a, 17b is respectively engaged in the hole 3a, 3b of the board 2a, 2b, such that the collar 14a, 14b is engaged in the annular peripheral rim 20a, 20b. To that end, the diameter of the pivot-shank 17a, 17b is smaller than that of the hole 3a, 3b of the board 2a, 2b, respectively.

The boards 2a, 2b are made integral in rotation using metal rings 21a, 21b provided on the perimeter of the holes 3a and 3b, respectively, and welded to each other by laser.

FIGS. 4 to 7 show another alternative embodiment of the invention. The elements shared with the first alternative are shown with the same references. The timepiece comprises a metal frame formed by a bridge 1a and a bottom plate 1b, and a wheel including a first board 2a provided with a toothing and a hole 3a, and a second board 2b provided with a toothing and a hole 3b. The boards 2a, 2b are made from diamond, for example by CVD.

The wheel is pivotably mounted on the bridge 1a and the bottom plate 1b using two pivoting members that each respectively comprises a bearing and a pivot engaged in their respective bearing.

In this alternative, the plate provided with a hole forming the bearing of the first pivoting member is merged with the board 2a provided with the hole 3a, said plate then being integral with the wheel. Likewise, the plate provided with a hole forming the bearing of the other pivoting member is merged with the board 2b provided with the hole 3b.

Each pivot is formed using a second plate 25a, 25b, comprising a planar element from which a cylindrical element protrudes, perpendicular to the planar element and forming a pivot-shank 26a, 26b, such that an annular peripheral rim 27a, 27b exists, in which the board 2a, 2b circulates, respectively.

Furthermore, in this alternative, a shaft 28 is provided mounted passing through the second plates 25a and 25b and the pivot-shanks 26a and 26b, the shaft 28 emerging from each plate 25a, 25b on the side opposite the pivot-shank 26a, 26b to be housed in a corresponding housing provided on the bridge 1a and the bottom plate 1b, respectively. The rod 28 is made integral with the bottom plate 1b by driving in or adhesion of one of its ends in the bottom plate 1b, the other end of the shaft 28 being engaged free in the bridge 1a, thereby allowing the assembly to be disassembled. Of course the shaft 28 can conversely be driven into the bridge, and left free in the bottom plate.

As shown in FIGS. 5 and 7, the second plates 25a, 25b and the pivot-shanks 26a, 26b have a circular central orifice 29 with two flats, the shaft 28 having a cylindrical section with two flats, with a shape complementary to the central orifice 29, so as to angularly maintain the plates 25a, 25b relative to the shaft 28, and thereby make them integral with said shaft 28, and therefore the bridge 1a and the bottom plate 1b. The plate 25a, 25b is made from diamond. The shaft 28 is made from a material able to have a plastic deformation to make it possible to slide and drive in the plates 25a, 25b on the shaft 28. The shaft 28 is for example made from steel.

According to the invention, the pivot-shank 26a, 26b is respectively engaged in the hole 3a, 3b of the board 2a, 2b, so that the board 2a, 2b is engaged in the annular peripheral rim 27a, 27b, respectively. To that end, the diameter of the pivot-shank 26a, 26b is smaller than that of the hole 3a, 3b of the board 2a, 2b, respectively.

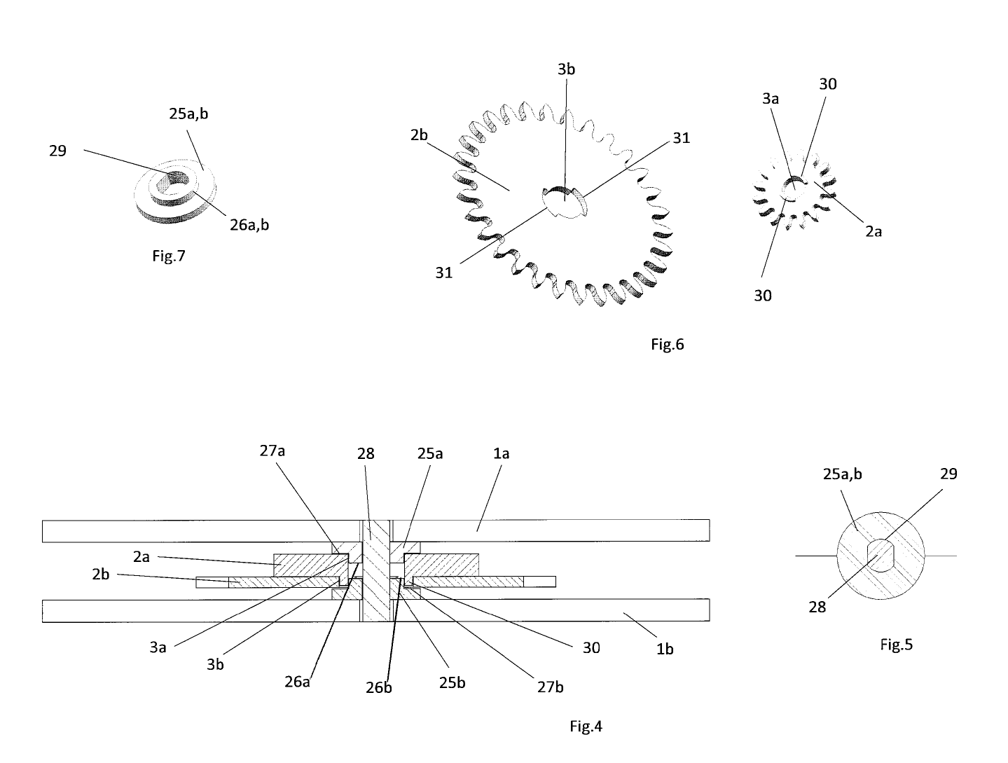

As shown in FIG. 6, the board 2a includes two lugs 30 in the form of two angular sectors protruding from said plate, and arranged opposite each other concentrically to the hole 3a. The hole 3b of the board 2b includes two notches 31, with a shape complementary to that of the lugs 30, and arranged opposite each other concentrically to the hole 3b. The lugs 30 are engaged in the notches 31 to make the boards 2a and 2b integral in rotation.

Of course the boards 2a and 2b can be made integral in rotation by replacing the notches 31 with two lugs complementary to the lugs 30, like those shown in FIG. 2. The lugs can also be replaced by metal rings like those used for the alternative of FIG. 3.

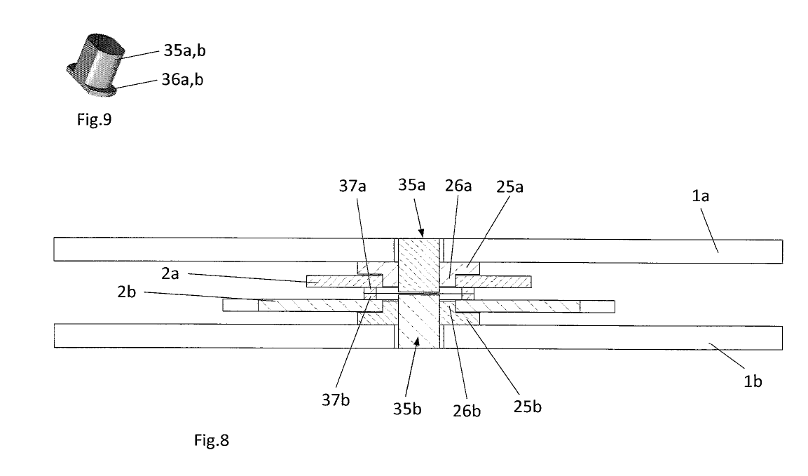

FIGS. 8 and 9 show another alternative of the invention, close to the alternative shown in FIGS. 4 to 7, the shared elements being shown with the same references.

In this alternative, a shaft 35a is mounted passing through the second plate 25a and in the pivot-shank 26a, the shaft 35a emerging on the side opposite the pivot-shank 26a to be housed in a corresponding housing provided on the bridge 1a. The shaft 35a is made integral with the bridge 1a by driving in or adhering the end thereof in the bridge 1a. Likewise, a shaft 35b is mounted passing through the second plate 25b and in the pivot-shank 26b, the shaft 35b emerging in the side opposite the pivot-shank 26b to be housed in a corresponding housing provided on the bottom plate 1b. The shaft 35b is made integral with the bottom plate 1b by driving in or adhering its end in said bottom plate 1b.

The plate 25a, 25b to form the pivot is the same as that shown in FIG. 7. As shown in FIG. 9, each shaft 35a, 35b has a cylindrical section with two flats, with a shape complementary to the central orifice 29 of the plate 25a, 25b, so as to make said plate 25a, 25b integral with the shaft 35a, 35b, respectively, and therefore the bridge 1a and the bottom plate 1b, respectively. Furthermore, each shaft 35a, 35b has a planar base 36a, 36b perpendicular to said shaft 35a, 35b, with dimensions substantially equal to those of the pivot-shank 26a, 26b. The shaft 35a, 35b is engaged in the orifice 29 of the plate 25a, 25b so that the pivot-shank 26a, 26 is in contact with the base 36a, 36b of the shaft 35a, 35b, respectively, so as to improve the maintenance of the plate 25a, 25b, respectively.

In the alternative shown in FIG. 8, the plates 2a, 2b are made integral in rotation using metal rings 37a, 37b like those used for the alternative of FIG. 3.

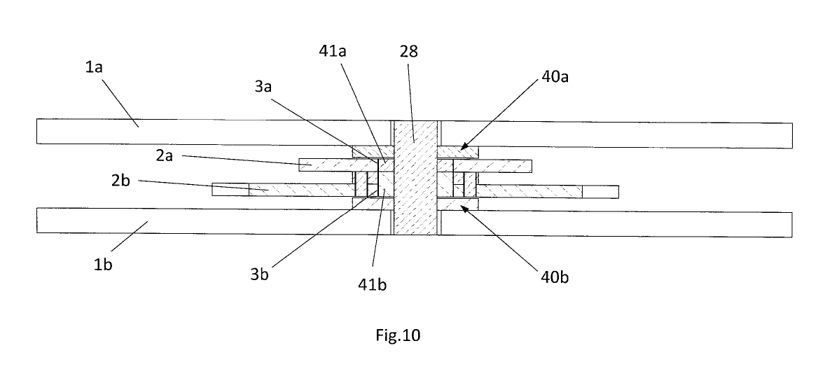

FIG. 10 shows another alternative of the invention, close to the alternative shown in FIGS. 4 to 7, the shared elements being shown with the same references.

In this alternative, each pivot is formed using a second plate 40a, 40b comprising a planar element and a separate cylindrical element, perpendicular to the planar element and forming a pivot-shank 41a, 41b engaged respectively in the hole 3a, 3b of the board 2a, 2b forming the bearing.

As in the alternative shown in FIGS. 4 to 7, a shaft 28 is provided mounted through the second plates 40a and 40b and in the pivot-shanks 41a and 41b, the shaft 28 emerging from each plate 40a, 40b on the side opposite the pivot-shank 41a, 41b to be housed in a corresponding housing provided on the bridge 1a and the bottom plate 1b, respectively. The second plates 40a, 40b and the pivot-shanks 41a, 41b have a circular central orifice with two flats, the shaft 28 having a cylindrical section with two flats, the shaft 28 having a cylindrical section with two flats, with a shape complementary to the central orifice, so as to angularly maintain the plates 40a, 40b relative to the shaft 28, and to thereby make them integral with said shaft 28, and therefore the bridge 1a and the bottom plate 1b.

In the different examples provided here for information, all of the elements are made from diamond with the exception of the frame and the through-shaft. Of course the elements can be made from silicon or another suitable material, only the contact surfaces between the different elements being covered with diamond or any other material or mixture of materials having a coefficient of friction and a wear rate equivalent to those of the diamond.

The diamond has a particularly low coefficient of friction, such that it is not even necessary to lubricate. It is thus possible to ensure the pivoting of a wheel or any other piece pivotably mounted with diamond-on-diamond friction, using pieces that can easily be manufactured by CVD.

1-11. (canceled)

12. A timepiece comprising a frame and a wheel pivotably mounted on said frame using at least one pivoting member that comprises a bearing and a pivot engaged in said bearing, the wheel having at least one board provided with a first hole, wherein at least the contact surfaces of the bearing and the pivot are made from at least one material intrinsically having a coefficient of friction and a wear rate equivalent to those of diamond and wherein said pivoting member comprises a first plate provided with a second hole and forming the bearing, and a second plate provided with a pivot-shank engaged in said first and second holes, and forming the pivot, said first and second plates being made integral one with the wheel, the other with the frame.

13. The timepiece according to claim 12, wherein the second plate to form said pivot comprises a planar element from which a cylindrical element protrudes forming the pivot-shank, the two elements being in a single piece.

14. The timepiece according to claim 12, wherein the second plate to form said pivot comprises a planar element and a cylindrical element forming the pivot-shank, the two elements being separate.

15. The timepiece according to claim 12, wherein the second plate comprises, on the side opposite the pivot-shank, a shank made integral with said second plate and the frame.

16. The timepiece according to claim 15, wherein said shaft is mounted passing through said second plate and in said pivot-shank.

17. The timepiece according to claim 12, wherein the board provided with the first hole and the first plate provided with the second hole are merged, said first and second holes being merged.

18. The timepiece according to claim 12, wherein said wheel includes two boards provided with a first hole and made integral in rotation, each board respectively being pivotably mounted in the frame using said pivoting member.

19. The timepiece according to claim 18, wherein said boards comprise, around their first respective hole, a metal ring.

20. The timepiece according to claim 18, wherein said boards respectively comprise complementary assembly means arranged to cooperate and make said boards integral in rotation.

21. The timepiece according to claim 18, wherein the shaft is mounted passing through the second plate and in the pivot-shank of the pivoting member of each board of said wheel.

22. The timepiece according to claim 12, wherein the material intrinsically having a low coefficient of friction and a low wear rate, making up at least the contact surfaces of the bearing and the pivot, is diamond.
